(19) United States
(12) Patent Application Publication
(10) Pub. No.: US 2006/0277477 A1
(43) Pub. Date: Dec. 7, 2006

(54) System and method for generating enhanced depiction of electronic files such as web files

(76) Inventor: Mark G. K. Christenson, Woodbury, MN (US)

Correspondence Address: Moss & Barnett, 4800 Wells Fargo Center, 90 South Seventh Street, Minneapolis, MN, 55402-4129, US

(21) Appl. No.: 11/143,838

(22) Filed: Jun. 2, 2005

(51) Int. Cl. G06F 9/00

(52) U.S. Cl. 715/760

(57) ABSTRACT

A system and method for providing enhanced content communicated in a Web or file page via a graphical element that is temporarily accessed when the user places his cursor or pointer over a pre-designated portion of the page is provided by the invention. Such a graphical element may constitute a thumbnail image or bubble that takes on many possible forms, including but not limited to a corporate logo, advertising sponsor's home Web page, photo, picture, or cartoon, animation or movie clip, music or other sound sequence, or enhanced textual message Usage of such graphical elements may provide a web page manager or sponsor additional needed space to communicate informational or advertising content within a Web or file page in which space is very limited without detracting from the appearance of the Web page.

### FIELD OF THE INVENTION

This invention relates to a method and system for providing an enhanced depiction of an electronic file, such as a web file, to entice a computer user to act affirmatively to select that web file via a browser. More specifically, when the user positions the cursor over a predesignated portion of text in a web or file page, a graphical image or additional text may temporarily overlay the web or file page to provide enhanced communication content.

### BACKGROUND OF THE INVENTION

The Internet is a vast network of computers that connects tens of thousands of smaller computer networks of the world's businesses, governments, universities, other organizations, and individuals. This on-line information system typically encompasses one computer system (“a server”) that makes information available for access by multiple other computer systems (“clients”). The server manages access by the client systems to this information, which can be structured as a set of independent on-line services. The server and client communicate via messages conforming to an established communication protocol that are sent over a communication channel such as a computer network or through a dial-up connection via a modem, which translates a computer's digital information into signals that can be transmitted over telephone lines.

Special software called a “browser program” executed on the client system provides the user access to the information managed by the on-line service. The browser thereby enables the user to selectively view, search, download, print, edit, or file the information managed by the server.

The Internet began as a collection of text-based information. However, a portion of the Internet called the World Wide Web (“Web” or “WWW”) greatly transformed the presentation of information on the Internet by allowing the additional use of photography, moving pictures, and sound to create informational presentations that approached the visual quality of television and the audio quality of recorded music. The Web, therefore, has become an invaluable communication tool for everyone from news organizations to entertainment providers to advertisers.

While the Web is the most obvious example of an on-line information service provider, other examples outside the Web exist. For example, private computer networks called “Intranets” operated within individual companies or other organizations can provide a ready communication forum much like the Web. Moreover, information may be communicated within a smaller scope between computers connected through a local area network (“LAN”).

Because of the millions of available Internet sites around the world, each site is assigned a separate and unique electronic address known as a uniform resource location (“URL”). Such an URL consists of a name in combination with a domain designation (e.g., “.com” for commercial or .“edu” for education). The Web user can simply type this URL address into a field within his browser, and be connected to the Website corresponding to that URL. This assumes however, that the user either knows the correct URL in advance, or is prepared to type the URL address after it is identified. An easier method for navigating the Web, therefore, is the use of “hyperlinks” contained within a Web page. Inserted into the Web page via the Hyper Text Markup Language (“HTML”) used to create Web documents published on the Web, the Web browser will permit a linked term such as a word appearing within the document (that is typically highlighted in a different color) to be clicked by a mouse or pointer to cause an associated Web document to be displayed. Hyperlinks therefore provide a simple, convenient, and effective means for an on-line information service provider to enable a user to navigate between associated pages of its Website or sourced from multiple Websites.

One of the most popular tools associated with the Web are search engines, which are software programs that offer users the opportunity to type in key words or phrases related to the information that they seek. The search engine will then review indices of information and sites available on the Internet and Web, thereby providing the user with a search report containing the addresses of sites that most closely match the informational request. These search reports may include hyperlinks associated with the URL address for a given site, which may then be clicked by the user to access that site.

Because of the amount of time that it takes to download a Web page containing an image, it has become convenient to include in the Web page instead a proportionally smaller version of the image called a “thumbnail”. Such a thumbnail appears exactly like the original image—just smaller. Because such a thumbnail also contains a corresponding smaller number of pixels (e.g., digital data) that needs to be downloaded, the user can access the Web page containing the pixel more quickly. The Web page will also typically include a hyperlink back to the original image document, so that by clicking on the thumbnail the user may readily access the original image. See, e.g., U.S. Pat. No. 6,275,829 issued to Angiulo et al.

It is known within the computer industry that software applications can include special features that provide temporary “bubbles” on the Web page when the user positions the cursor over a designated position on the screen. For example, a tool bar in a word processing or email program might provide such bubbles that identify to the user the functionality of the buttons contained in the tool bar. U.S. Pat. No. 6,563,514 issued to Samar discloses software that can be installed by the end user on his computer to provide additional functionality to another program. For instance, a temporary bubble might be generated by hovering the cursor over a particular word appearing in a word processed document to provide a definition of the word, thesaurus alternatives, or a translation of the word into another language. As another example, a user using a Web browser to visit a bookstore Website could hover the cursor over the title of a book to produce a bubble containing the price, author, or availability of the book, or other books by the same author.

U.S. Pat. No. 6,583,781 issued to Joshi et al. teaches a method incorporated into a computer program for evaluating the movement, direction, speed, acceleration, etc. of a cursor to automatically try to interpret the user's intent in moving the cursor over the graphical user interface. For example, when the cursor slows down over a particular word or position on the screen, the normal time period required to trigger a pop-up text window or bubble associated with that word or position might be reduced to alleviate frustration by the end user over otherwise slow response time.

Much effort apparently has also been directed within the computer industry to help the user to navigate the Web where he may visit a large number of Websites in a single browser session. In some cases, the URL for a visited Web page may be saved in a sequential, stacked “history” list, thereby possibly allowing the user to return to previously visited Web page by selecting its description form the history list. The user may also travel between the Web pages identified in the standard history list by selecting the forward or backward buttons provided by the browser. However, the use of such forward or backward traversal without relevant visual feedback can be confusing for the end user. It can also be time-consuming, particularly for an end user relying upon a slow dial-up connection to the Web.

Therefore, published application US 2002/0129114 filed by Sundaresan et al. discloses a system for helping a user to navigate the Web by providing thumbnail images of Web pages previously visited that act as visual cues to remind the user of the page's content. A text-based abstract of the page content could be substituted for the thumbnail image. As discussed within published application US 2004/0003351 filed by Sommerer et al., such a browser navigational tool could adopt the form of visit nodes displayed in one or more trees that graphically illustrate the user's navigation between resource pages, including thumbnail images of the resource pages.

Efforts have also been made to provide the user with a preview of a Web page before he accesses it in order to facilitate a determination by the user of whether or not the page is likely to be relevant to his search query. Such a preview might be in the form of an abstract specially written by the server-side browser in response to information provided by a destination computer connected by the Web, thereby permitting the user through his client-side browser to obtain preview information before acting to activate the Web page in question via a hyperlink. Such abstract information might constitute the size of the Web page to be accessed, or whether it contains offensive content. See published application US 2001/0037359 filed by Mockett et al.

In other systems taught by the prior art, thumbnail images of the Web page to be activated via a hyperlink are provided to the user. See, e.g., published applications US 2002/0129114 filed by Sundaresan et al.; US 2004/0205514 filed by Sommerer et al.; and US 2003/0014415 and US 2005/0010860 filed by Weiss et al.

Published application US 2004/0167933 filed by Lomelin-Stoupignan et al. also teaches a system for allowing a user to customize the search page resulting from usage of a search engine by including thumbnail previews of the Web pages corresponding to their hyperlinks. It is important to note, however, that these thumbnail images merely provide exact duplicates, albeit, on a smaller scale, of the Web pages that the end user either has already visited or proposes to visit. They do not provide any additional enticement beyond the content of the Web page to induce the user to take affirmative action to visit that Web page or Website by clicking on the associated hyperlink.

Because of the millions of computer users who browse the Internet and its Web each day, it has become a popular vehicle for advertisers. Many Web pages have inserted into them advertisements from sponsoring companies, promoting the sponsor's product and services. These sponsored links listings typically contain a short text entry intended to encourage the user to traverse to the sponsor's identified Website. In some cases, these sponsored links listings also may contain a hyperlink which may be clicked by the user to activate the sponsor's Website. Each time the user clicks on the hyperlink or otherwise activates the sponsor's Website, the sponsor is charged a fee by the owner of the primary Website. This is how these types of Websites make enough revenue to stay in business.

Due to the structural limitations of Websites, the amount of space available on the Web page that can be dedicated to sponsored links is comparatively small. Because of the Website owner's natural desire to maximize the number of sponsor's advertisements that can be carried in the sponsored links field, the amount of space allowed each sponsor to advertise its product or service is very small. Therefore, it would be desirable to provide a computer-based system for a Web page that enables the sponsor to exploit additional space through a pop-up entry to advertise its product or service to the end user, while keeping such pop-up entries and the primary text messages within the perimeter of the sponsored links section of the Web page for the sake of the Web page owner who desires to communicate the primary information contained within the Web page.

### SUMMARY OF THE INVENTION

A system and method for providing enhanced content communicated in a Web or file page via a graphical element that is temporarily accessed when the user places his cursor or pointer over a pre-designated portion of the page is provided by the invention. Such a graphical element may constitute a thumbnail image or bubble that takes on many possible forms, including but not limited to a corporate logo, advertising sponsor's home Web page, photo, picture, or cartoon, animation or movie clip, music or other sound sequence, or enhanced textual message Usage of such graphical elements may provide a web page manager or sponsor additional needed space to communicate informational or advertising content within a Web or file page in which space is very limited. Because such graphical element is only temporarily visible to the user, it does not subtract from space allocated to other informational or advertising sites on the Web of file page. The temporary bubble or thumbnail image may also constitute a specific visual image that is used to attract the attention of the user to entice him into selecting an associated Web or file page via a hyperlink.

### BRIEF DESCRIPTION OF THE DRAWINGS

In the accompanying drawings:

FIG. 1 is a screen shot of a Google Webpage containing search results from use of the Google search engine.

FIG. 2 is a screen shot of the home Web page of Wendy's International.

FIG. 3 is a screen shot of a Web page from an article published on the Web.

FIG. 4 is a screen shot of a Web page published by RecipeRewards.com.

FIG. 5 is a schematic of a Web page containing a sponsored link from an advertiser.

FIG. 6 is a schematic of a Web page from a Website incorporating the graphical display element of the present invention in its invisible state in association with the sponsored advertising link of FIG. 5.

FIG. 7 is a schematic of the Web page incorporating the graphical display element from FIG. 5 in its invisible state in association with the sponsored advertising link.

### DETAILED DESCRIPTION OF THE PREFERRED EMBODIMENT

A system and method from providing enhanced visceral content to a Web page or other electronic file page is provided by the invention. Such invention may take the form of a graphical element such as a thumbnail image or bubble that is temporarily accessed by the user when he places his cursor or pointer over a pre-designated portion of the page, but disappears when the cursor or pointer is removed by the user from that pre-designated portion of the page. This invention is particularly suited for providing special visual and/or audible images or supplemental textual messages to advertisements contained within a Web page to viscerally entice the user to select an associated Website without detracting from the overall appearance of the principal Web page.

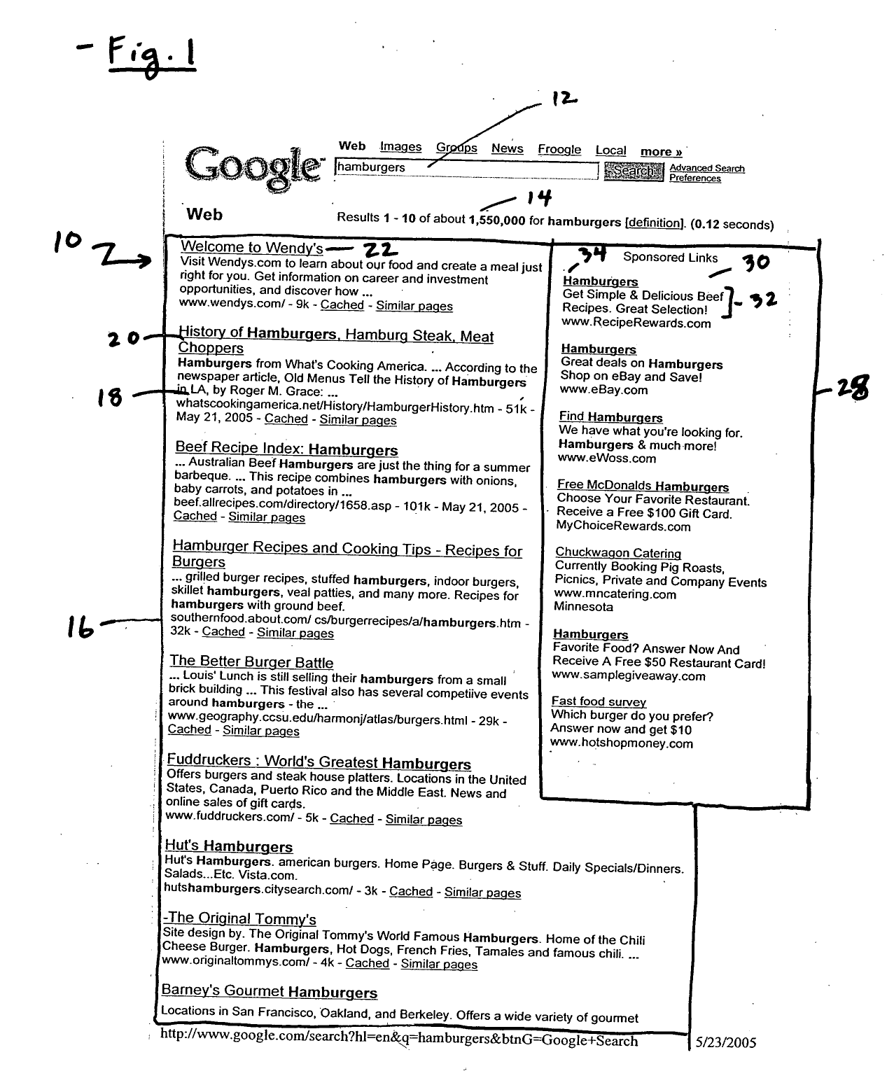

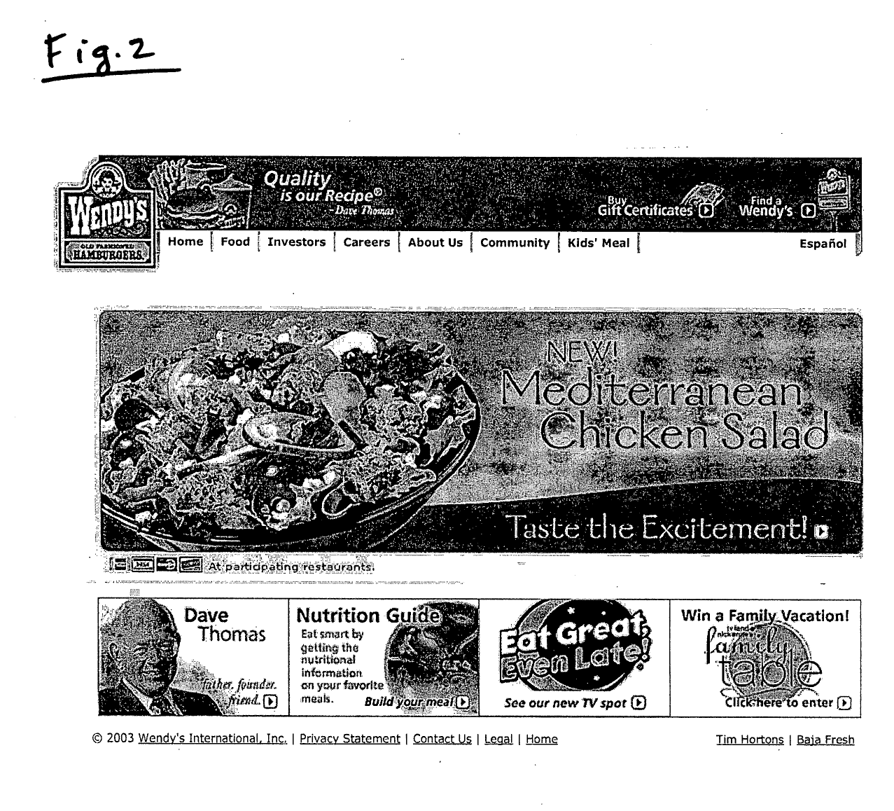

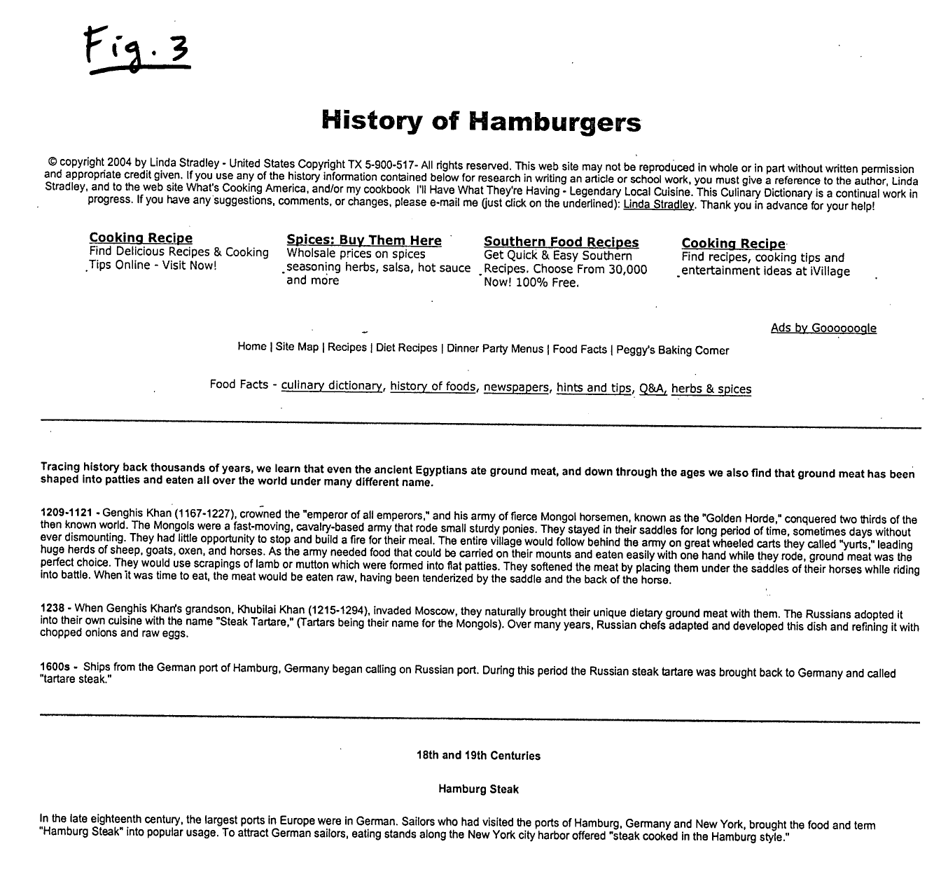

FIG. 1 shows a conventional view of a Web of file page, in this case, the results page from a search run conducted using the Google Search Engine for Websites relevant to the search inquiry “hamburgers.” Hamburgers is identified in the search field 12 of the Web page 10. The search results field 14 indicates that approximately 1,550,000 Websites were identified by the Google search engine that are relevant to the topic of hamburgers. Nine of these Websites appear within the primary subject field 16 of Web page 1. Containing a short text excerpt 18 to indicate the relevance of the Website to the hamburger topic, each of these entries also includes a title 20 that doubles as a hyperlink. By clicking on the hyperlinked text, the user will automatically be taken via the browser to the website associated with that hyperlink entry. For example, clicking on the “Welcome to Wendy's” title 22 transports the user to the Wendy's International, Inc. home page shown in FIG. 2. Similarly, clicking on the “History of Hamburgers” title 24 takes the user to an article shown in FIG. 3 that traces the historical antecedents of America's favorite food. These hyperlinks provide a quick and convenient method for the user to access the Websites identified by the Google search engine.

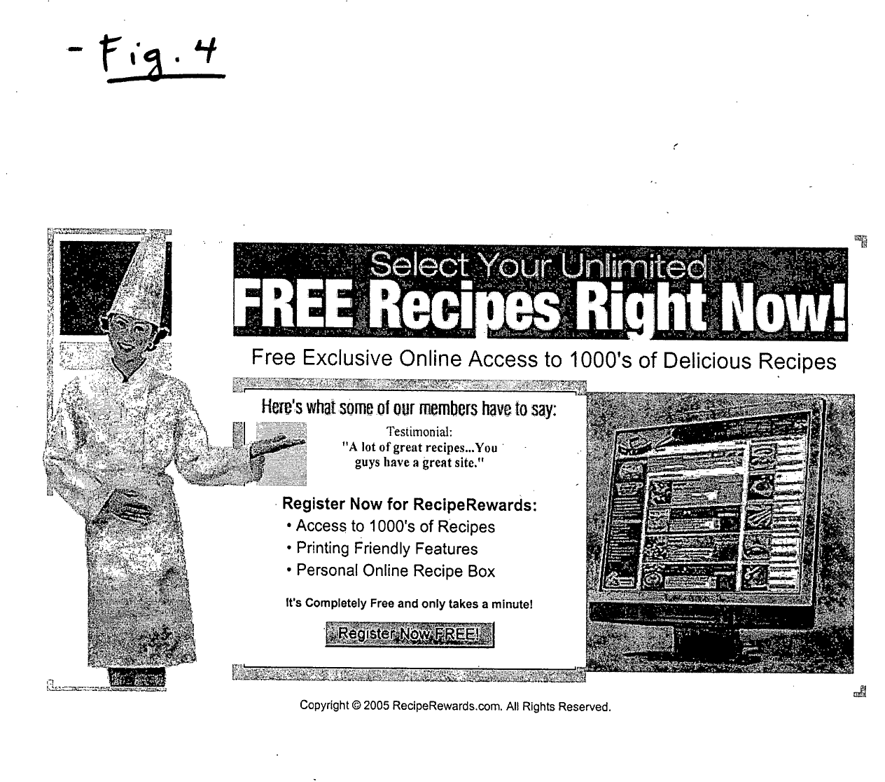

Also appearing in Web page 10 is “Sponsored Links” field 28 that contains seven advertising entries from sponsors who will pay Google each time their advertising entry is selected by Internet users. In this case, for example, Recipe Rewards.com has placed an advertisement 30 constituting the textual content 32 “Get Simple & Delicious Beef Recipes. Great Selection!” Because Google does not want to dedicate more than approximately one third of its Web page 10 to the Sponsored Links field 28, and wishes to insert at least seven advertisements within this field, the amount of space available to RecipeRewards.com for their advertising message 32 is quite limited. By clicking on this hyperlinked title “Hamburgers” 34 in this advertisement 30, the user is automatically transported to the sponsor's Website shown in FIG. 4 that promises “free exclusive online access to 1000's of delicious recipes.”

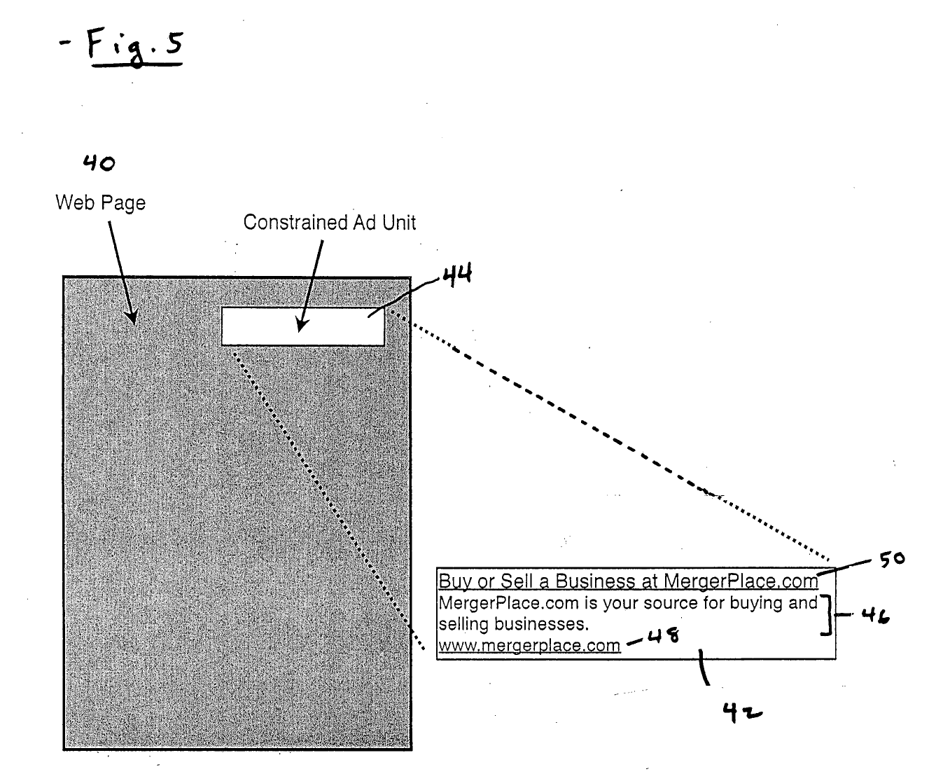

FIG. 5 shows the system and method of the present invention for manipulating a graphical image or other object with respect to Web page 40. For purposes of illustration, the Web page 40 contains an advertisement 42 within constrained ad unit field 44 sponsored by MergerPlace.com. The ad 42 contains two lines of text 46 (“MergerPlace.com is your source for buying and selling businesses”), and identification of the URL 48 for the associated Website, and a title 50 which also doubles as a hyperlink for transporting the user to the associated Website after it is clicked by the mouse or pointer.

Enclosing the Web page produces a HTML iframe (inline frame) element having a fixed width and height that defines the constrained area 44 in which the ad unit 42 is to be displayed, as is known in the art. The src (source) parameter of the iframe, in turn, specifies the location of the ad unit content with respect to the constrained ad area 44. HTML Document Object Model (“DOM”) is used to represent the ad unit content 46, 48, 50.

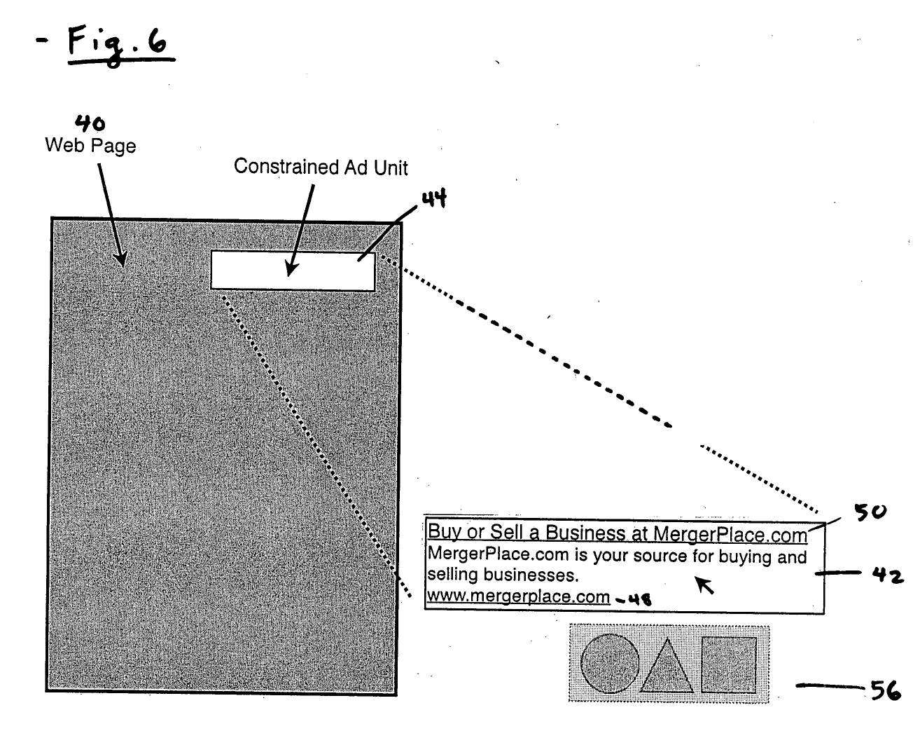

Embedded within the text content of the ad unit is a reference to a graphical display element 56 in combination with external JavaScript source code, which implements the behavior of the graphic element, as described more fully below. FIG. 6 illustrates this graphic element 56 in association with the ad unit 42. Both the text and the graphical element are positioned in absolute terms relative to the origin of the iframe bounding box, wherein the graphical element is initially positioned so that its bounding box is completely outside the bounding box of the iframe, as illustrated in FIG. 6. The JavaScript program code uses the JavaScript language to bind the graphical element to the HTML DOM code that defines the ad unit content 42.

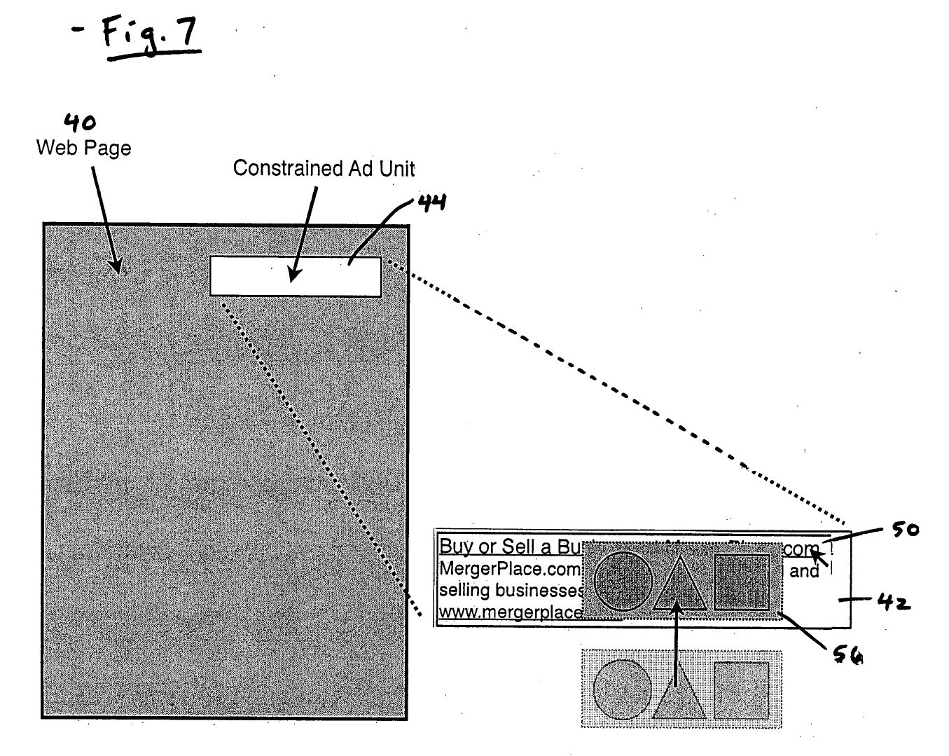

JavaScript event handlers are installed on a selected element of the textual ad unit—e.g., the ad title 50—for mouse-in and mouse-out events. Ordinarily, the graphical element will lie completely outside of the iframe bounding box that contains the textual ad unit, thereby rendering the graphical element invisible. However, once the user hovers the mouse over the title 50, as shown in FIG. 7, the mouse-in element triggers a function to move graphical element 56 so that it is completely contained inside the iframe bounding box for the ad unit to cause it to become visible. This initial mouse-in event simply sets a flag that indicates that the graphical element is to be made visible on the Web page to the user.

Preferably, a timer will be invoked once the mouse hovers over the ad unit title lasting, e.g., 0.5 second. The delay caused by this timer before the graphical element is moved within the ad unit iframe bounding box to render it visible ensures that the user really intended to hover the mouse over the activating element of the graphical element to make it visible, as opposed to merely moving the mouse across the Web page for a different, unrelated reason.

If the cursor is still hovering over the ad unit title once this initial timer expires, then the flag will be set and the graphical element will be accordingly moved inside the iframe bounding box to make it visible. The graphical element can be immediately moved inside the iframe bounding box to make it visible. More preferably, a second timer can be set to delay the emergence of the visible graphical element for a sufficient time period to enable the user's eye to see it appear. Even more preferably, the graphical element could be moved along incremental positions across the Web page in response to the series of additional timer events to cause it to “fly” into the ad unit space in a more “eye catching manner.”

Such timers are invoked by use of the JavaScript “setTimeout( )” function, and are configured to call the appropriate pre-defined functions, which perform the desired actions upon “firing.” The positional change of the graphical element is effected by adjusting the “top” and “left” positional attributes of the graphical object via the appropriate JavaScript DOM bindings.

Once the mouse is moved by the user away from the ad unit title or other activating element, a function will be invoked to clear the flag, which indicates that the graphical element should now be made invisible. Again, the same timer sequence that was invoked when the mouse-in event occurred can now be used by this mouse-out event trigger to cause the graphical element to move to its standby position outside of the iframe bounding box to render it invisible.

Graphical element 56 is represented by ● ▴ ▪ in FIGS. 6-7 to indicate that it can adopt a number of different forms. For example, it could constitute a thumbnail image of the corporate logo of the advertising sponsor. Especially if this logo is well known within the consumer market, its sudden visible emergence might enhance the chances of the user deciding to click on the hyperlink to access the associated Website or Web page. Such decisions to select a Website or Web page frequently are made on impulse, so anything that increases the probability of a user clicking on the ad hyperlink to access the advertiser's fuller message communicated in the associated Web page or Website will greatly assist the sponsor in realizing its marketing objectives. Likewise, the Web page owner will benefit since it is typically compensated each time that the advertising site is accessed via the sponsored ad.

Alternatively, the graphical element might constitute a thumbnail image of the advertising sponsor's home Web page. Such an image, especially if it is visually stimulating, might be sufficient to prompt the user to decide to click on the ad's hyperlink to access the associated Web page or Website.

Another possible embodiment of the present invention is the use of an animation or sound sequence as the graphical element. Such an intriguing site and sound, in particular if done in combination, might entice the user to access the sponsored Website or Web page. For instance, an automobile advertisement sponsored by General Motors might include a graphical element in the form of a short video showing the featured car rotated for viewing from multiple angles or driving off to stimulate the user's senses.

It is also possible for purposes of this invention for the graphical element to contain text. Such a graphical element might constitute an expansion of the textual message offered by the ad sponsor on the primary Web page. This would enable the sponsor to overcome the severe space limitations characteristic of most Web pages. Alternatively, the primary advertising message might be contained within the text of the ad site, but the graphical element might consist of a special coupon from the sponsor (“Buy 2, Get 1 Free”) to entice the user to access the associated Web page or Website.

Thus, for purposes of this invention, the graphical element may constitute any series of pictures, images, photographs, animations, drawings, sounds, music, colors, text, or other visual or audible stimulation, or a combination thereof, that is likely to draw the user's attention to the sponsor's message contained within the Web page, and entice him to follow the sponsor's message via the text and hyperlink to seek additional information or make a purchase decision via the associated Web page or Website. Such graphical element might blink on and off after activation to provide additional visual stimulation.

While this invention has been primarily discussed within the context of Web-based advertising, it should be appreciated that the invention is equally applicable to other environments, including but not limited to, news reporting, education, entertainment, sports, etc. For example, an educational article on jungle animals appearing in a Website might enable the user to trigger an image of a tiger or elephant when the mouse hovers over a predesignated position on the Web page in order to arouse the interest of the user to entice her to finish the article. Similarly, a news article on a celebrity or other personality might contain a graphical element triggered by the user in the form of a recent and interesting photograph of that person. Indeed, one of the primary advantages of the present invention is that the creator of the Web page is not limited to a static image for the graphical element that exists at the same time that the Web page is created. Instead, the Web page can be designed to seek a current photo or image for the graphical element triggered by the end user. In this manner, the article or other informational content of the Web page may stay current in real time to stimulate the interest of the user.

The present invention has been illustrated in FIGS. 5-7 by a single advertisement appearing on the Web page. It should be understood that the iframe bounding box might contain multiple advertisements from different sponsors, each entailing a limited textual message. When the user hovers the mouse over the activating element like a title contained in a particular advertisement to trigger the process for rendering the associated graphical element visible, the graphical element can be brought within the iframe bounding box to overlay one or more of the other advertisements, thereby leaving the advertisement of primary interest visible in its entirety to the end user. In this manner, the combination of advertising text and adjacent visible graphical element is more likely to attract the curiosity of user to entice him to click on the hyperlink to access the associated Web page or Website of the sponsor.

The above specification and drawings provide a complete description of the design and structure of the system and method of the present invention for operatively associating temporary graphical elements with the textual message of a Web page or other electronic file. However, many other embodiments of the invention can be made without departing from the spirit and scope of the invention. For example, the primary forum need not be a Web page, but could instead be part of an Intranet system operated, e.g., within a company, or be an electronic file that is shared between computer users. Similarly, the activating element for triggering the graphical element need not be the hyperlinked term, but could instead be another logical location within the textual message that is in the vicinity of likely mouse traffic by the end users. Likewise, selective operation of the graphical element can be defined by other computer codes besides JavaScript that are known in the art. Therefore, the present invention resides in the claims hereinafter appended.

We claim:

1. A system for enhancing the visceral content of a page of an electronic file, the system comprising a computing platform for executing an enhancement application being designed and configured for:
(a) detecting an invocation event associated with an activation control embedded within the electronic file;
(b) retrieving a graphical element associated with the electronic file page in response to the detection of the activation control; and
(c) temporarily displaying the graphical element in overlaid relation to the electronic file page in a predetermined position on such page until the invocation event is terminated.

2. The system of claim 1, wherein the electronic file page is a Web page accessible on the Internet or WorldWide Web.

3. The system of claim 2, wherein the Web page further contains at least one online advertisement.

4. The system of claim 3, wherein the Web page further contains a linking control embedded therein for retrieving a target resource page associated with the advertisement appearing on the Web page.

5. The system of claim 4, wherein the embedded linking control is a hyperlink operatively connected to the target resource page.

6. The system of claim 1, wherein the invocation event comprises a cursor or mouse positioned by a user over a predetermined position on the electronic file page.

7. The system of claim 1 further comprising a timer delay function for delaying the display of the graphical element until the passage of a predetermined time period after detection of the invocation event.

8. The system of claim 1 further comprising a timer delay function for delaying the disappearance of the graphical element until the passage of a predetermined time period after the invocation event is terminated.

9. The system of claim 1, wherein the graphical element comprises a visual image selected from the group consisting of a photograph, picture, drawing, cartoon, or schematic.

10. The system of claim 1, wherein the graphical element comprises a video image selected from the group consisting of an animation or movie clip.

11. The system of claim 1, wherein the graphical element comprises an audio image selected from the group consisting of music, speech, or other sounds.

12. The system of claim 1, wherein the graphical element comprises expanded text in furtherance of the textual message contained in the electronic file page.

13. The system of claim 3, wherein the graphical element comprises a thumbnail image of the Website of the advertising sponsor.

14. The system of claim 3, wherein the graphical element comprises a thumbnail image of the corporate logo of the advertising sponsor.

15. The system of claim 1, wherein the graphical element is retrieved from a database portion of the system in which it was stored for operative association with the electronic file.

16. The system of claim 1, wherein the graphical element is retrieved in real time with respect to the time that the invocation event is detected from an independent database operatively associated through the system with the electronic file.
